(19) United States
(12) Patent Application Publication
(10) Pub. No.: US 2007/0162702 A1
(43) Pub. Date: Jul. 12, 2007

(54) System and method for acquiring data from a cache in a distributed network

(76) Inventors: Yang Lei, Cary, NC (US); Hasan Muhammad, Raleigh, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/327,615

(22) Filed: Jan. 6, 2006

(51) Int. Cl. G06F 12/00

(52) U.S. Cl. 711/118

(57) ABSTRACT

The On-Demand Cache Acquisition Tool, or “OCAT,” is a computer implemented system and process for acquiring data from a cache in a distributed network of computers, comprising: receiving a query for the data; sending the query to a remote server in the distributed network; receiving a reply from the remote server indicating that the data is in a cache coupled to the remote server; requesting a copy of the data from the remote server; receiving the copy of the data from the remote server; and storing the data in a local memory.

### FIELD OF THE INVENTION

The present invention relates generally to electrical computers and specifically to transferring data between multiple computers.

### BACKGROUND OF THE INVENTION

Computer cache is a high speed storage mechanism, usually comprising a portion of a computer's volatile memory. Computers use cache to store data for quick retrieval. Computers can then reuse the cached data without repeating the steps of querying a database for duplicate data. Computers locate and retrieve cached data faster than performing new database queries. Storing recently used data or frequently used data in cache enhances the performance and speed of a computer.

In a distributed computer server network, it is customary to disseminate newly cached data from one server to all other servers on the network. When a server obtains data from a database, the server stores the data in its cache, then “pushes” the data to all other servers on the network. Each server stores a copy of the data in its own cache. Pushing data to every server uses bandwidth, which has the effect of slowing down traffic on the distributed network. Furthermore, storing the same data on every server uses up cache on servers that might not even need the data.

Thus, a need exists for a system and method for servers in a distributed network to acquire or “pull” cached data from the distributed network only when neeeded.

### SUMMARY OF THE INVENTION

The On-Demand Cache Acquisition Tool, or “OCAT” meets the need identified above. The OCAT is a computer implemented system and process for acquiring data from a cache in a distributed network of computers, comprising: receiving a query for the data; sending the query to a remote server in the distributed network; receiving a reply from the remote server indicating that the data is in a cache coupled to the remote server; requesting a copy of the data from the remote server; receiving the copy of the data from the remote server; and storing the data in a local memory.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents an exemplary computer network.

FIG. 2 describes programs and files in memory on a computer.

FIG. 3 is a flow chart of the Monitoring Component.

FIG. 4 is a flow chart of the Data Acquisition Component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “On-Demand Cache Acquisition Tool” or “OCAT”.

Additionally, OCAT is described below with reference to an exemplary distributed network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary distributed network 100 has only a limited number of nodes, including server computer 105, server computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125. Specifically, network connection 125 may utilize a JAVA Message Service (JMS) messaging system coupled with an Enterprise Bus System wherein all network nodes use a specified port to exchange various kinds of messages related to the status and administration of the network.

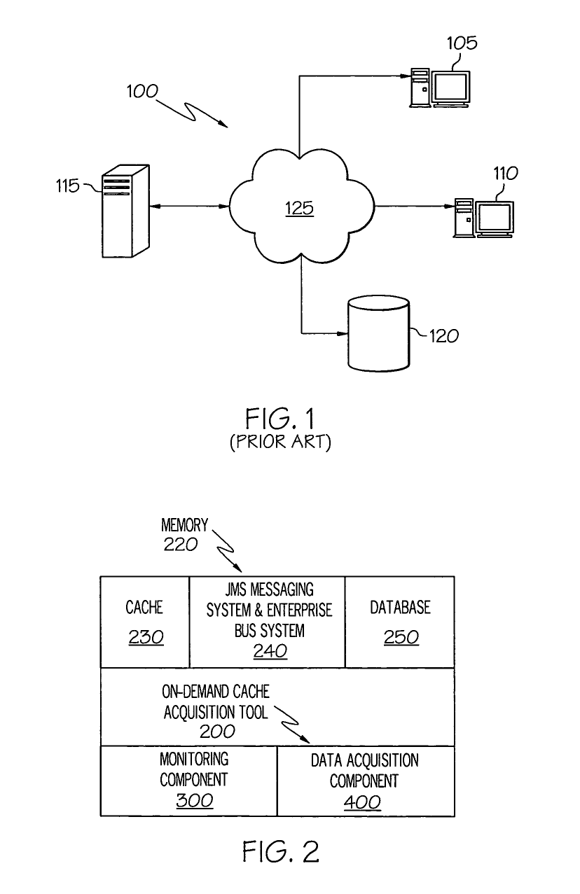

On-Demand Cache Acquisition Tool (“OCAT”) 200 typically is stored in a memory, represented schematically as memory 220 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 220. As depicted in FIG. 2, though, memory 220 may include additional data and programs. Of particular import to OCAT 200, memory 220 may include local Cache 230, JMS Messaging System coupled with Enterprise Bus System 240, and Database 250. OCAT 200 has two components: Monitoring Component 300 and Data Acquisition Component 400. For descriptive purposes here, OCAT 200 runs on server computer 115.

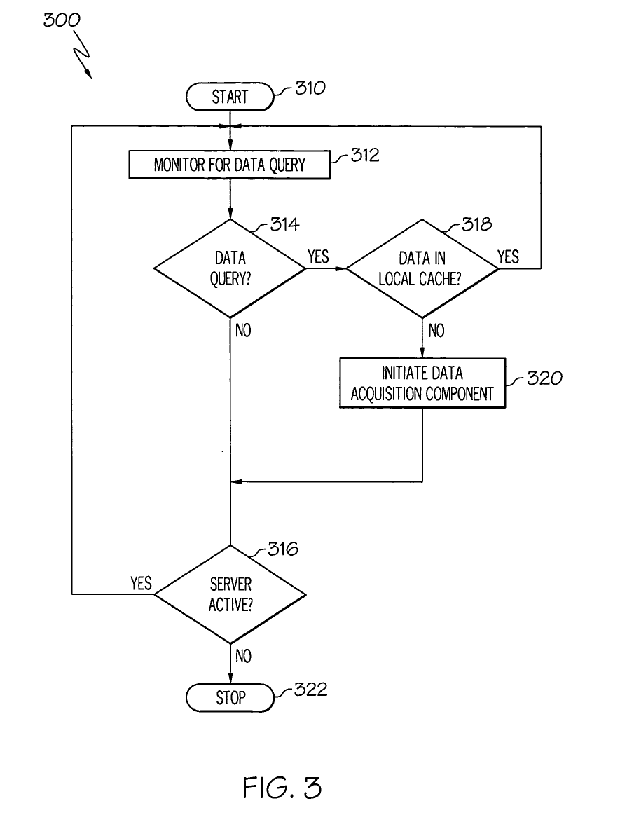

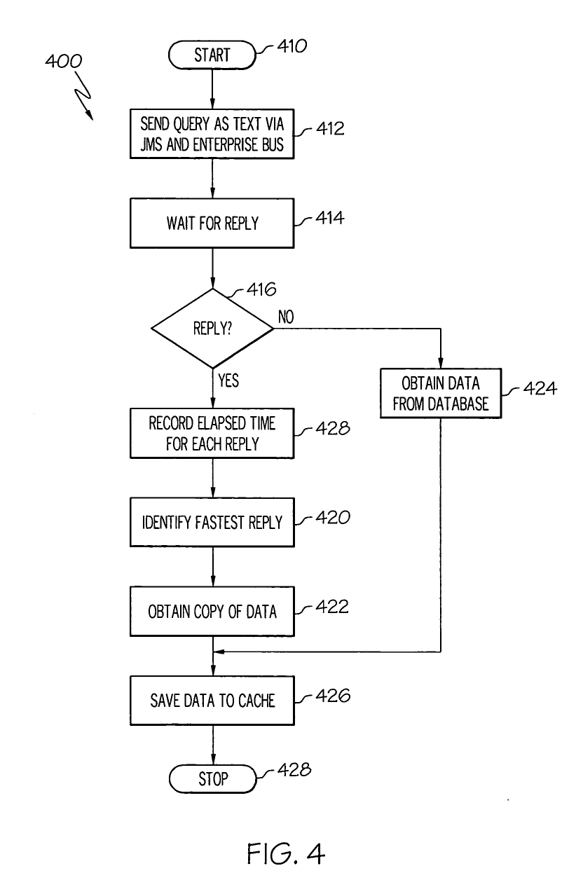

FIG. 3 illustrates the operation of one embodiment of Monitoring Component 300. Monitoring Component 300 starts as part of the start-up routine whenever the server computer 115 initializes (310). Monitoring Component 300 monitors server computer 115 for a data query (312). Whenever a data query occurs (314), Monitoring Component 300 determines if the requested data is already stored in local Cache 230 (318). If the data is not cached locally, Monitoring Component 300 initiates Data Acquisition Component 400 (320). If the requested data is already in local Cache 230, Monitoring Component 300 continues to monitor server 115 for other data queries (312-316). Monitoring Component 300 continues to monitor server computer 115 as long as server computer 115 is active (316) and stops when server computer 115 shuts down (322).

Data Acquisition Component 400 starts when initiated by Monitoring Component 300 (410). Data Acquisition Component 400 forwards the data query as text via JMS Messaging System and Enterprise Bus System 240 to server computers 105 and 110 on distributed network 100 (412). Data Acquisition Component 400 waits for a text response (414), if any, from server computers 105 and 110 indicating that the requested data is available (416). Data Acquisition Component 400 records the elapsed time of response from server computers 105 and 110 (418) and identifies the server computer with the fastest response time (420). Data Acquisition Component 400 requests and obtains a copy of the cached data from the server with the fastest response time (422). If neither server computer 105 nor 110 respond, Data Acquisition Component 400 requests and obtains the data from Database 250 (424). Data Acquisition Component 400 saves the data in local Cache 230 (426) and stops (428).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for acquiring data from a cache in a distributed network of computers, the computer implemented process comprising:
receiving a query for the data;
sending the query to a remote server in the distributed network;
receiving a reply from the remote server indicating that the data is in a cache coupled to the remote server;
requesting a copy of the data from the remote server;
receiving the copy of the data from the remote server; and
storing the data in a local memory.

2. The computer implemented process of claim 1 wherein the query is sent to the remote server as a string in a message object via a JMS messaging system coupled to an enterprise bus system.

3. The computer implemented process of claim 1 wherein the reply is a string in a message object and is received via a JMS messaging system coupled with an enterprise bus system.

4. The computer implemented process of claim 1 wherein:
the distributed network has more than one remote server;
the reply is received from more than one remote server; and
the copy of the data is requested from the remote server that replied in the fastest time.

5. A computer implemented process for providing data from a cache in a distributed network of computers, the computer implemented process comprising:
receiving a query for the data from a remote server in the distributed network;
determining if the data is in a local cache;
replying to the remote server if the data is in the local cache;
receiving a request for a copy of the data; and
sending the copy of the data to the remote server.

6. The computer implemented process of claim 5 wherein the reply to the remote server is a string in a message object sent via a JMS messaging system coupled to an enterprise bus system.

7. A computer program product comprising a computer useable medium having a computer readable program, wherein the computer readable program when executed on a computer causes the computer to perform a process for acquiring data from a cache in a distributed network of computers, the process comprising:
receiving a query for the data;
sending the query to a remote server in the distributed network;
receiving a reply from the remote server indicating that the data is in a cache coupled to the remote server;
requesting a copy of the data from the remote server;
receiving the copy of the data from the remote server; and
storing the data in a local memory.

8. The computer program product of claim 7 wherein the query is sent to the remote server as a string in a message object via a JMS messaging system coupled with an enterprise bus system.

9. The computer program product of claim 7 wherein the reply is a string in a message object and is received via a JMS messaging system coupled with an enterprise bus system.

10. The computer program product of claim 7 wherein:
the distributed network has more than one remote server;
the reply is received from more than one remote server; and
the copy of the data is requested from the remote server that replied in the fastest time.

11. The computer program product of claim 7 further comprising a second computer readable program, wherein the second computer readable program when executed on the remote server causes the remote server to perform a process comprising:
receiving the query for the data;
determining if the data is in a cache coupled to the remote server;
sending a reply if the data is in the cache coupled to the remote server;
receiving a request for a copy of the data; and
sending the copy of the data to the computer.
